(19) United States
(12) Patent Application Publication
(10) Pub. No.: US 2020/0346596 A1
(43) Pub. Date: Nov. 5, 2020

(54) LICENSE PLATE PROTECTOR

(71) Applicants: Darrell Allen, Upper Marlboro, MD (US); Cyrene Allen, Upper Marlboro, MD (US)

(72) Inventors: Darrell Allen, Upper Marlboro, MD (US); Cyrene Allen, Upper Marlboro, MD (US)

(21) Appl. No.: 16/401,431

(22) Filed: May 2, 2019

(51) Int. Cl. B60R 13/10; G09F 7/18

(52) U.S. Cl. CPC B60R 13/105; G09F 2007/1865; G09F 7/18

(57) ABSTRACT

A blocker for preventing ice and snow from being collected on a license plate of a vehicle. The blocker has a first side, a second side and a top. The first side and the second side are triangular in shape and preferably substantially similar. The top is rectangular and is preferably eleven (11) inches in length. The top is coupled to the first side and the second side. The blocker is coupled to the license plate holder and thus protecting the license plate. There is a window in each of the first side, second side and top. The window in the first side and the window in the second side are triangular in shape and preferably translucent. The window in the top is rectangular in shape and preferably five and one-half (5.5) inches in length. The top may also have one or more solar panels to convert solar energy into electrical energy.

### FIELD OF THE INVENTION

This invention relates to ice and snow blockers. More particularly, it relates to ice and snow blockers for vehicles.

### BACKGROUND

An ice scraper is a handheld tool for removing frost, ice, and snow from windows, usually on automobiles. Basic scrapers have a plastic blade and handle, though some have blades made out of metal. More complex models often include brushes to help remove collected snow, or squeegees to remove water if the ambient temperature is near the melting point. Alternatively, the handle can be inside a glove-like enclosure to help keep the user's hands warm and dry when using the scraper.

The blade of an ice scraper is usually flat if it is made out of metal, though some varieties include ridges that can be helpful if it is necessary to break up a sheet of ice (such as what collects in freezing rain). Plastic blades tend to have a more complex shape with several thick “fingers” linked together. This form helps the blade to flex, since most modern car windows have a slight curvature. The “fingers” also often have ridges on top, so the scraper can be flipped over to break up thick ice. More complex designs exist to improve ice clearance on curved glass on automobiles.

Ice and snow are not always in a convenient place to be removed from a vehicle or it may be built up to such a point that excessive energy and strength is required to remove the ice and snow, this is particularly a problem for a front and a back of a vehicle mainly near the license plate. This often results in an injury to the person attempting to remove the snow. Further, damage to the vehicle may occur from the scaping and pushing of the ice scraper. Therefore, there is a need to have a blocker for ice and snow accumulating on a vehicle.

### BRIEF DESCRIPTION OF THE DRAWINGS

FIG. 1 is an illustrated view of an exemplary blocker for ice and snow.

FIG. 2 is an illustrated view of the use of the blocker of FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

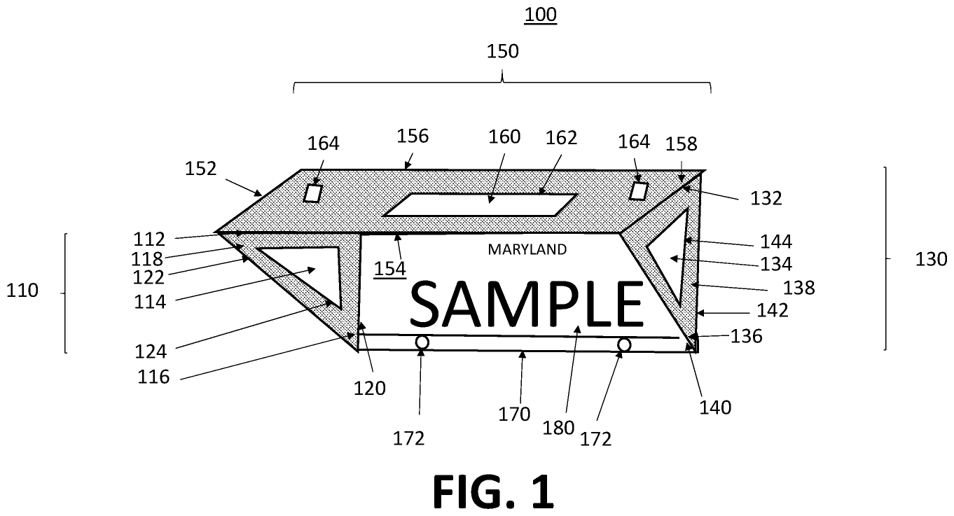

Referring to FIG. 1, an illustrated view of a blocker 100 for snow and ice, also known as “The License Plate Protector”. The blocker 100 is useful keeping ice build-up and snow from blocking the view of a back of a vehicle. The blocker 100 preventing the ice and snow protects the vehicle from damage caused by attempting to chip away the ice or scraping the snow coupled to the vehicle. Further, a person that may use a traditional ice scraper may be injured from using the traditional ice scraper, whereas the blocker 100 does not require physical exertion by the user.

The blocker 100 has a first side 110, a second side 130 and a top 150. The first side 110 of the blocker 100 and the second side 130 of the blocker 100 are typically mirror images, but the first side 110 of the blocker 100 and the second side 130 of the blocker 100 may be different. The blocker 100 is preferably made of a hard plastic, but may be made of other strong, durable materials, such as aluminum, steel, PCV, etc. The blocker 100 is preferably slightly larger than a license plate 180, but may be the same size as the license plate 180 or substantially larger than the license plate 102.

Optionally and/or additionally, the first side 110 may have an extender (not shown). The extender is coupled to the street side 132 of the first side 110. The extender extends the street side 122 of the first side 110 preferably in a range of two and one-half (2.5) to four (4) inches but may extend more or less as desired.

The blocker 100 is preferably coupled to a license plate holder 170. The license plate holder 170 is coupled to the vehicle preferably by a plurality of screws which are configured to be positioned in a plurality of screw openings 172 of the license plate holder 170. The license plate holder 170 is configured to couple the license plate 180 to the vehicle. The plurality of screw openings 172 is preferably four (4), but may be any number that may securely couple the license plate 180 and the license plate holder 170 to the vehicle.

The first side 110 of the blocker 100 has a top 112, a center 114, a back 116, an inside 118, an outside 120, a street side 122, and a window 124. The window 124 is configured to be inserted into the center 114 of the first side 110 of the blocker 100. The window 124 is useful for providing light to penetrate the first side 110 for the user to have light when looking or working on an area around the blocker 100. The first side 110 is preferably a triangular shape, but may be any other shape such as rectangular, square, etc. The first side 110 is made preferably of a hard plastic material but may be made of other strong, durable materials such as steel, PVC, aluminum, etc. The first side 110 extends preferably in a range of two and one-half (2.5) to four (4) inches but may extend more or less as desired.

The window 124 of the first side 110 is preferably the same shape as the first side 110 of the blocker, but may be a different shape. The window 124 is preferably translucent but may be semi translucent, darkened, etc.

The second side 130 of the blocker 100 has a top 132, a center 134, a back 136, an inside 138, an outside 140, a street side 142, and a window 144. The window 144 is configured to be inserted into the center 134 of the second side 130 of the blocker 100. The window 144 is useful for providing light to penetrate the second side 130 for the user to have light when looking or working on an area around the blocker 100. The second side 130 is preferably a triangular shape, but may be any other shape such as rectangular, square, etc. The second side 130 is made preferably of a hard plastic material but may be made of other strong, durable materials such as steel, PVC, aluminum, etc.

Optionally and/or additionally, the second side 130 may have an extender (not shown). The extender is coupled to the street side 142 of the second side 130. The extender extends the street side 142 of the second side 130 preferably in a range of two and one-half (2.5) to four (4) inches but may extend more or less as desired.

The window 144 is preferably the same shape as the second side 130 of the blocker, but may be a different shape. The window 144 is preferably translucent but may be semi translucent, darkened, etc. The material of the second side 130 is preferably the same as the first side 110 but may be different. The window 144 of the second side 130 is preferably the same material as the window 124 of the first side 110.

The top 150 has a first side 152, a front side 154, a back side 156, a second side 158, a center 160, a window 162 and one or more solar panels 164. The top 150 is preferably a rectangular shape, but may be any other shape such as round, oblong, trapezoidal, square, etc. The top 150 is made preferably of a hard plastic material but may be made of other strong, durable materials such as steel, PVC, aluminum, etc.

The top 150 may have an extender (not shown). The extender coupled to the front side 154 of the top 150 extending the top 150. The extender may extend the front side 154 of the top 150, thereby creating a lip, in a range of two and one-half to three and one-half (2.5-3.5) inches.

The first side 152 of the top 150 is coupled to the top 112 of the first side 110 of the blocker 100. The second side 158 of the top 150 of the blocker 100 is coupled to the top 132 of the second side 130 of the blocker 100.

The window 162 is configured to be inserted into the center 160 of the top 150 of the blocker 100. The window 162 is useful for providing light to penetrate the top 150 for the user to have light when looking or working on an area around the blocker 100, as well as, exposing the license plate 190 number. The window 162 is preferably five and one-half (5.5) inches in length. The window 162 is preferably rectangular in shape, but may be square, round, etc.

The window 162 is preferably the same shape as the top 150 of the blocker 100, but may be a different shape. The window 162 is preferably translucent but may be semi translucent, darkened, etc.

Optionally and/or additionally, the top 150 may have the one or more solar panels 164. The one or more solar panels 164 may be configured to be positioned on one or more portions of the top 150. The one or more solar panels 164 are useful for converting solar energy into electrical energy. The electrical energy produced by the one or more solar panels 164 may be useful in powering a heating element (not shown), such as a heating coil, an electrical heating element, etc. The electrical energy produced by the one or more solar panels 164 may also be useful in powering lamps (not shown) such at night or in darkened times, the user has a lamp to light the area for ease of use and/or repair. The lamps (not show) are preferably LED lamps, but may be LCD, CFL, etc.

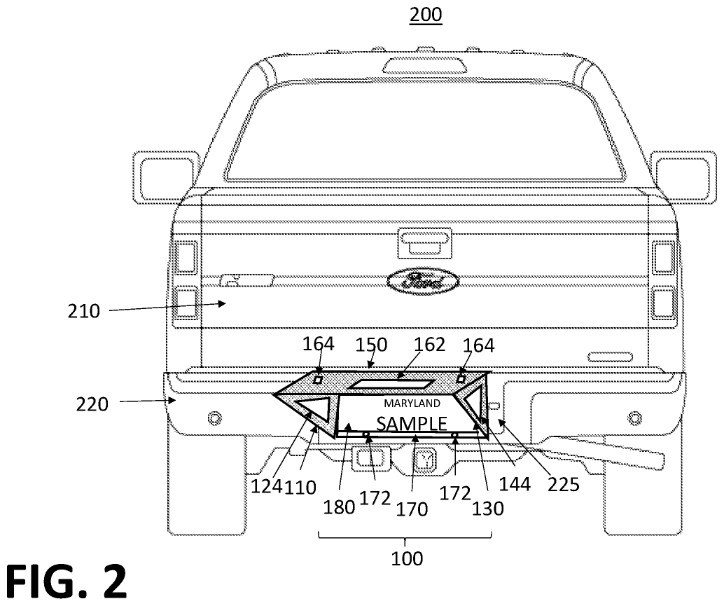

Moving now to FIG. 2, the blocker 100 of FIG. 1 is coupled to a vehicle 200. The vehicle 200 has a bumper 220, a rear end 210 and a license plate indentation 225. The license plate indentation 225 is part of the bumper 220 and is configured to have a license plate 180. The license plate holder 170 couples the license plate 180 to the bumper 220.

The blocker 100 is coupled to the license plate holder 170 at two of the screw openings (not shown). The window 124 of the first side 110 allows for light to show through the first side 110. The window 144 of the second side 130 allows for light to show through the second side 130. The window 162 of the top 150 allows for light to show through the top 150 and for the license plate 180 to be visible to see the license plate number. The solar panels 164 convert solar energy to electrical energy, thus powering the heating mechanism (not shown) and/or lamps (not shown).

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A blocker for protecting a license plate from ice and snow, the blocker comprising consisting of:
a first side;
a second side;
a top, wherein in the top has a first side, a second side, a front side and a back side, and wherein the top having one or more solar panels, the one or more solar panels for converting solar energy to electrical energy;
the first side of the top being coupled to the first side of the blocker;
the second side of the top being coupled to the second side of the blocker;
a window, the window coupled to the top of the blocker, wherein the window having the same shape as the top of the blocker;
an extender, the extender being removably coupled to a street side of the first side; and
the blocker configured to cover a license plate and configured to being coupled to a license plate holder.

2. The blocker of claim 1, wherein the top being eleven (11) inches in length.

3. The blocker of claim 1, wherein the blocker being a hard-plastic material.

4. The blocker of claim 1, wherein the first side of the blocker and the second side of the blocker being the same size.

5. The blocker of claim 1, wherein the first side of the blocker being triangular in shape.

6. The blocker of claim 1, wherein the second side of the blocker being triangular in shape.

7. The blocker of claim 1, wherein the top being rectangular in shape.

8. The blocker of claim 1, further comprising:
a window, the window being configured in a center of the top.

9. The blocker of claim 8, wherein the window being translucent.

10. The blocker of claim 8, wherein the window being five and one-half (5.5) inches in length.

11. The blocker of claim 8, wherein the window being rectangular in shape.

12. The blocker of claim 1, further comprising:
a window, the window being configured in a center of the first side.

13. The blocker of claim 12, wherein the window being translucent.

14. The blocker of claim 12, wherein the window being triangular in shape.

15. The blocker of claim 1, further comprising:
a window, the window being configured in a center of the second side.

16. The blocker of claim 15, wherein the window being translucent.

17. The blocker of claim 15, wherein the window being triangular in shape.

18. (canceled)

19. (canceled)

20. (canceled)

21. A blocker for protecting a license plate from ice and snow, the blocker consisting of:
a first side;
a second side;
a top, wherein in the top has a first side, a second side, a front side and a back side, wherein the top having one or more solar panels, the one or more solar panels for converting solar energy to electrical energy, wherein the top being rectangular in shape, and wherein the top having a length being eleven (11) inches in length;
the first side of the top being coupled to the first side of the blocker;
the second side of the top being coupled to the second side of the blocker, wherein the second side of the blocker being a same size as the first side of the blocker, wherein the blocker having a shape being triangular, wherein the second side of the blocker being triangular in shape;
a window, the window being configured in a center of the top, wherein the window being translucent, wherein the window having a shape being rectangular, and wherein the window being five and one-half (5.5) inches in length;
an extender, the extender being removably coupled to a street side of the first side; and
the blocker configured to cover a license plate and configured to being coupled to a license plate holder, wherein the blocker being made of a hard-plastic material.
